(19) United States
(12) Patent Application Publication
(10) Pub. No.: US 2010/0143551 A1
(43) Pub. Date: Jun. 10, 2010

(54) USE OF N-VINYLIMIDAZOLE POLYMERS TO IMPROVE THE VALUE-DETERMINING PROPERTIES OF BIOLOGIC FERMENTED SOLUTIONS

(75) Inventors: Nikolaj Schmid, Mannheim (DE); Gero Spika, Limburgerhof (DE); Milan Jaron, Linkebeek (BE)

Correspondence Address: CONNOLLY BOVE LODGE & HUTZ, LLP, P O BOX 2207, WILMINGTON, DE, 19899, US

(73) Assignee: BASF SE, LUDWIGSHAFEN (DE)

(21) Appl. No.: 12/663,113

(22) PCT Filed: Jun. 3, 2008
(86) PCT No.: PCT/EP08/56806

§ 371 Date: Dec. 4, 2009

(30) Foreign Application Priority Data
Jun. 6, 2007 (EP) 07109731.5

(51) Int. Cl. C12H 1/04

(52) U.S. Cl. 426/271; 426/13

(57) ABSTRACT

Processes for improving a value-determining property of a biological fermented solution, which comprise treating the biologically fermented solution after the fermentation, per 100 liter, with 1 to 3000 g of a polymer which comprises 50-99.5% by weight of N-vinylimidazole and 0 to 49.5% by weight of another copolymerizable monomer incorporated by polymerization and is produced in the absence of oxygen and polymerization initiators and also in the presence of 0.5 to 10% by weight, based on the monomers, of a crosslinker.

The patent application relates to the use of a crosslinked N-vinylimidazole polymer and also a process for improving the value-determining properties of biological fermented solutions by treatment with a crosslinked polymer based on a N-vinylimidazole.

Using the crosslinked N-vinylimidazole polymer improves the value-determining properties of biologically fermented solutions.

The process of beer production essentially proceeds as follows: wort preparation, fermentation, storage, filtration, stabilization, packaging. The wort obtained by roasting processes is fermented in the presence of brewer's yeasts, which is followed by a storage for a defined period of time, during which post-fermentation takes place. Thereafter, customarily the beer is clarified in order to remove coarse particles, which is followed by a customarily physicochemical stabilization in which polyphenols and tannoids and also proteins are removed. The clarification can proceed, for example, by centrifugation, flotation or filtration. These separation techniques can be carried out individually or successively. The finished beer stabilized in this manner, or retail beer, is then fed to packaging. For production of beers and similar alcoholic drinks, see also Römpp Chemielexikon [Römpp's chemistry lexicon], 9th Edition, Vol. 1, pp. 108-111, Georg Thieme Verlag, Stuttgart, Germany.

The metabolic activity of yeast, in the course of fermentation, forms, in addition to ethanol, a multiplicity of intensive-aroma volatile substances. These fermentation by-products are chiefly alcohols and esters.

The quality of biologically fermented solutions such as, for example, beer and beer-like drinks is characterized by the sum of the value-determining properties. Among the value-determining properties, it is possible to distinguish odor, flavor, foaming, microbiological and physicochemical stability of the biologically fermented solutions and also their drinkability. Drinkability designates an attribute of a drink to be attractive for future consumption also owing to its typical flavor (“brand loyalty”).

These value-determining properties should not change adversely during storage and transport. However, because of various parameters, the properties are changed during storage. These include, for example, autoxidative changes, energy input by light or transport and also the proportion of certain components present after fermentation such as, for example, fatty acids, sugars or amino acids.

For physical clarification of the beer, frequently use is made of minerals such as kieselguhr, perlite or bentonite. For removing polyphenols, use can be made of, for example, crosslinked polyvinylpyrrolidone. For removing proteins, use is also made of silica.

It is also known to combine the filtration step with the stabilization step by using filter aids which simultaneously make possible mechanical separation of yeast cells and a stabilization.

EP-A 88964 describes a process for producing water-insoluble and scarcely swellable polymers of basic N-vinylheterocycles which can be used for producing complexes with transition metals.

According to EP-A-4 38 713, use is made of polymers based on basic vinylheterocycles for removing heavy metals from wine and wine-like drinks. The polymers are said to be able to be regenerated after treatment with dilute mineral acids.

EP-A 781 787 describes the use of water-insoluble and slightly swellable polymers of basic N-vinylheterocycles for producing complexes with heavy metal ions. The complexes with heavy metal ions are said to serve for removing sulfur compounds from wine and wine-like drinks.

EP-A 642 521 discloses removing aluminum ions from drinks such as beer, wine, wine-like drinks or fruit juice. However, the treatment of beer described therein relates to a finished retail beer which had already been subjected to a physicochemical stabilization. The treatment described in this document did not influence the typical aroma.

The object of the invention was therefore to develop an improved process for improving the value-determining properties, in particular the aroma profile, of beer and beer-like drinks. The object was especially to ensure from the start an improved aroma profile.

This object is achieved by a process for improving the value-determining properties of biological fermented solutions which comprises treating the biologically fermented solution, per 100 liter, with 1 to 3000 g of a polymer of 50-99.5% by weight of N-vinylimidazole which comprises 0 to 49.5% by weight of another copolymerizable monomer incorporated by polymerization and is produced in the absence of oxygen and polymerization initiators and also in the presence of 0.5 to 10% by weight, based on the monomers, of a crosslinker.

The invention also relates to the use of an N-vinylimidazole polymer for improving the value-determining properties.

Biologically fermented liquids are, according to the invention, in particular beer and beer-like drinks. As a beer product, a beer intermediate is designated which is not a finished beer or retail beer. The beer product has still not been fed to clarification or physicochemical stabilization.

In the treatment by the process according to the invention, an unfiltered material can be treated directly after fermentation and post-fermentation, that is to say before clarification and/or physicochemical stabilization proceed. It can also be advisable to use the polymer to be used according to the invention in the upstream production steps such as water treatment, mashing, wort production or fermentation. According to a further embodiment, the treatment can proceed together with the first filtration step after fermentation and post-fermentation.

The amount of polymer used is 1 to 3000, preferably 50 g to 200, particularly preferably 40 to 80 g, per 100 l.

The N-vinylimidazole polymer can be added as solid or added in the form of an aqueous suspension. The solids content of the suspension can be 1 to 30% by weight, in particular 5 to 10% by weight.

The production of the N-vinyl polymers used according to the invention is known per se and described extensively in EP-A 88964, EP-A 438713 and EP-A 642521 and the disclosure of said publications is hereby explicitly incorporated herein by reference.

Preferably, the N-vinyl polymer used comprises 70 to 99.5% by weight of N-vinylimidazole, 0 to 29.5% by weight of the copolymerizable monomer and 0.5 to 10% by weight of the crosslinker.

Preference, in addition, is given to copolymers of 50 to 99.5% by weight of N-vinylimidazole and N-vinylpyrrolidone as comonomers. As crosslinker, N,N′-divinylimidazolidin-2-one preferably comes into consideration.

Very particular preference is given to a polymer of 90% by weight of N-vinylimidazole, 7% by weight of N-vinylpyrrolidone and 3% by weight of N,N′-divinylimidazolin-2-one.

The figures in % by weight relate in this case to the total amount of monomers and crosslinkers.

The N-vinyl polymers used according to the invention are in part commercially available, for example as Divergan® HM from BASF.

In processing terms, the treatment according to the invention can be carried out like a filtration. The polymer can be used, for example, as in the patent application DE 19547761 A1 as bulk material for precoat filtration.

The polymerized vinylheterocycle can be used both as what is termed a precoat layer or metered in continuously in precoat filtration.

In addition it is possible to incorporate the polymer in various forms in a matrix, for example in filter candles, filter modules, filter sheets, membranes or ion exchange columns.

The above-described matrix can comprise the following materials:

Synthetic polymers such as polyethylene, polypropylene, polybutylene, polyamide, polystyrene, polyethersulfones or polyesters, celluloses, inorganic materials such as kieselguhr, perlites, asbestos, glass, aluminum oxides, silicon oxides, activated carbon and/or sand, or resins.

When it is incorporated into a matrix, the quantitative ratio of N-vinylimidazole polymer to matrix materials is customary 1:10 to 1:1.

The raw beer products treated according to the invention are assessed with respect to their flavor stability.

For assessing the flavor stability, in principle two methods may be differentiated:
1. analytical assessment by means of gas chromatography, HPLC and ESR and
2. sensory assessment by various tasting methods such as, for example, tasting as described by the DLG (German Agricultural Society) or by Eichhorn.

The following analytical methods can be used in measurement of flavor stability:
1. higher aliphatic alcohols and volatile esters
2. beer aroma compounds (alcohols, esters, acids)
3. indicators of aging (heat and oxygen indicators, aging components)
4. stability index
5, tasting as described by the DLG
6. tasting as described by Eichhorn

In addition, the physicochemical stability can be studied by determination of the content of tannoids, proteins and total polyphenols.

By means of the use according to the invention of an N-vinylimidazole polymer it is possible, in a simple manner, to achieve stabilization of the raw fermented product which means that later on storage and transport of the finished retail product the formation of aging substances is suppressed. In contrast to the processes described in the prior art, which are only targeted at clarification or post-treatment of a finished drink, that is to say at a time point at which the aroma formation is essentially complete, the process according to the invention intervenes at a time point at which, owing to the highly complex chemical composition and the yeasts still present, aroma formation is still taking place. By the adsorption of heavy metal ions such as copper or iron, or of aluminum ions in the unfiltered material, the aroma profile can be influenced. By the adsorption of phenolic components such as, for example, 3,4-dihydroxycinnamic acid, these compounds can be withdrawn from a conversion by enzymatic reactions and thereby the aroma profile beneficially affected. The process according to the invention does not replace later filtration by means of a filter aid for removing relatively coarse particles or cell residues and also does not replace stabilization with, for example, silica, crosslinked polyvinylpyrrolidones and similar substances. According to the invention, in particular, the formation of the aroma substances and the chemical composition important for stability on aging with respect to the typical aging indicators is influenced.

It was surprising for those skilled in the art that, using a treatment directly after the fermentation, later a greater stability of the finished product with respect to value-determining properties can also be achieved.

### EXAMPLES

The test instructions cited in the examples hereinafter relate to the analytical instructions freely available on request from the TU Munich, Lehrstuhl für Technologie der Brauerei I, Weihenstephan, Federal Republic of Germany, which also correspond to the instructions of the Central European Brewing Analysis Commission MEBAK.

The treatment was performed in an industrial pilot plant. 50 l of an unfiltered beer of the Pilsner beer type were treated. In this process 20 g, 40 g or 80 g of Divergan HM were added per 100 l of unfiltered material in filtration with kieselguhr (Becogur®).

### Analytical Assessment

### Determination of Aging Indicators

Test method No. GC007/96

See Table 1 for results

### Higher Aliphatic Alcohols and Volatile Esters

Test method No. GC008/96

See Table 2 for results

### Sensory Assessment

### Taste Testing as Described by DLG

The DLG taste-testing method assesses the beers on a five-point scale, with 5 denoting pure and without offtaste. It is advisable to perform the assessment in 0.5-point steps.

### Aging Taste Test as Described by Eichhorn

Eichhorn suggested a taste-testing method for the sensory assessment of aged beers. In this method, only the freshness or degree of aging of a beer is assessed. The criteria are based in this case on those of the DLG method, wherein only odor, flavor, and the quality of the bitterness are rated. As a scale for rating the aging flavor, marks between 1 and 4 can be awarded. In this process a mark of 1 represents absolutely fresh and 4 represents extremely aged. In addition, the testers assess the acceptance in percent. For example, an acceptance of 20% means that only every 5th tester would accept this beer. As a preliminary it is essential to train the taste-testing panel for the aging flavor.

For prediction of the flavor stability, the beers are force-aged. The samples for this are shaken for 24 hours in order to simulate the distribution path and thereafter stored for 4 days at 40° C. in the dark. The taste testing proceeds as fresh compared with forced. For the sensory assessment of flavor stability, taste testing is performed under the 5-point method of the DLG and in addition the aging state as described by Eichhorn is rated using a 4-point scale. Alternatively, for the forced aging, naturally stored beers (returned samples) can and should be taste-tested for aging regularly.

The results of the DLG taste testing and aging taste testing are shown in the table hereinafter.

TABLE
Taste testing according to DLG and aging
taste testing as described by Eichhorn
Taste testing as described by DLG:
Rating in half-point steps from 1 to 5
Please indicate the aroma impression!

| | | | Drinking | Flavor | | Bitterness |
|---|---|---|---|---|---|---|
| No. | Sample | Odor | quality | richness | Liveliness | quality |
| A | A Fresh | 4.0 | 4.5 | 4.0 | 4.0 | 4.0 |
| B | A Forced | 3.0 | 3.0 | 4.0 | 4.0 | 3.5 |
| C | B Fresh | 4.0 | 4.0 | 4.0 | 4.0 | 4.0 |
| D | B Forced | 2.5 | 2.5 | 3.5 | 4.0 | 3.5 |

Aging taste testing:
1 = Fresh
2 = Slightly aged
3 = Strongly aged
4 = Extremely aged

| | | | Drinking | Bitterness | Acceptance [%] | | | | | |
|---|---|---|---|---|---|---|---|---|---|---|
| No. | Sample | Odor | quality | quality | 100 | 80 | 60 | 40 | 20 | 0 |
| A | A Fresh | 1.0 | 1.0 | 1.0 | x | | | | | |
| B | A Forced | 2.0 | 2.5 | 2.0 | | | x | | | |
| C | B Fresh | 1.0 | 1.0 | 1.0 | x | | | | | |
| D | B Forced | 3.0 | 3.0 | 2.5 | | | | | x | |

Acceptance only relates to aging of the beer

TABLE 1
Aging indicators

| | | | | | | | Forced | Forced | Unfiltered |
|---|---|---|---|---|---|---|---|---|---|
| | 20 g/hl | | 40 g/hl | | 80 g/hl | | Becogur | Eisengur | material |
| Aging indicators in μg/l | fresh | forced | fresh | forced | fresh | forced | filtrate | filtrate | fresh |
| 3-Methylbutanal | 6.7 | 13 | 7.2 | 10 | 6.4 | 9.0 | 8.7 | 10 | 5.9 |
| 2-Furfural | 3.1 | 55 | Traces | 36 | Traces | 24 | 122 | 113 | Traces |
| Methylfurfural | 3.9 | 5.3 | 4.1 | 5.3 | 4.1 | 5.7 | 5.4 | 5.2 | 4.2 |
| Benzaldehyde | 1.0 | 1.1 | Traces | 1.2 | 0.7 | 0.7 | 1.8 | 1.4 | Traces |
| 2-Phenylethanal | 5.0 | 9.5 | 4.0 | 6.2 | 3.5 | 6.2 | 10 | 10 | 4.4 |
| Succinic acid diethyl ester | 0.7 | 1.0 | Traces | 1.8 | Traces | 1.2 | 2.2 | 1.9 | 1.0 |
| Nicotinic acid ethyl ester | 6.1 | 11 | 4.2 | 11 | 4.9 | 12 | 9.9 | 8.7 | 4.3 |
| Phenylacetic acid ethyl ester | 0.8 | 0.8 | Traces | 1.1 | 0.8 | 0.9 | 1.1 | 0.9 | 0.7 |
| 2-Acetylfuran | 1.2 | 4.7 | Traces | 5.3 | Traces | 3.5 | 10 | 8.8 | Traces |
| 2-Propionylfuran | Traces | Traces | Traces | Traces | Traces | Traces | Traces | Traces | Traces |
| Gamma-nonalactone | 21 | 25 | 22 | 26 | 20 | 22 | 27 | 23 | 23 |
| Σ Heat indicators | 24 | 80 | 22 | 62 | 20 | 47 | 149 | 136 | 23 |
| Σ Oxygen indicators | 13 | 23 | 11 | 18 | 11 | 16 | 20 | 21 | 10 |
| Σ Aging components | 43 | 115 | 37 | 93 | 36 | 74 | 189 | 174 | 39 |

TABLE 2
Higher aliphatic alcohols and volatile esters

| | Filtrate | Filtrate | Filtrate | Unfiltered |
|---|---|---|---|---|
| Concentrations in mg/l | 20 g | 40 g | 80 g | material |
| Acetaldehyde | 5.0 | 5.3 | 4.7 | 4.1 |
| Propan-1-ol | 6.4 | 6.1 | 5.9 | 6.0 |
| Ethyl acetate | 16 | 21 | 18 | 17 |
| 2-Methylpropanol | 6.1 | 5.8 | 5.6 | 5.6 |
| 3-Methylbutanol | 22 | 21 | 30 | 29 |
| 2-Methylbutanol | 4.5 | 4.3 | 8.2 | 8.0 |
| 2-Methylpropyl acetate | n.d. | Traces | n.d. | n.d. |
| Butyric acid ethyl ester | 0.1 | 0.1 | 0.1 | 0.1 |
| 3-Methylbutyl acetate | 1.2 | 1.4 | 1.2 | 1.2 |
| 2-Methylbutyl acetate | 0.1 | 0.1 | 0.1 | 0.1 |
| Ethyl hexanoate | 0.1 | 0.2 | 0.1 | 0.1 |

1-11. (canceled)

12. A process for improving a value-determining property of a biological fermented solution, which comprises treating the biologically fermented solution after the fermentation, per 100 liter, with 1 to 3000 g of a polymer which comprises 50-99.5% by weight of N-vinylimidazole and 0 to 49.5% by weight of another copolymerizable monomer incorporated by polymerization and is produced in the absence of oxygen and polymerization initiators and also in the presence of 0.5 to 10% by weight, based on the monomers, of a crosslinker.

13. The process according to claim 12, wherein use is made of a polymer which, as comonomer, comprises exclusively N-vinylpyrrolidone or N-vinylcaprolactam or a mixture of the two incorporated by polymerization.

14. The process according to claim 12, wherein use is made of a polymer which, as crosslinker, comprises N,N′-divinylethyleneurea incorporated by polymerization.

15. The process according to claim 12, wherein use is made of a polymer which is produced in the presence of a reducing agent.

16. The process according to claim 12, wherein use is made of a polymer which is produced in the presence of water at 30 to 150° C.

17. The process according to claim 12, wherein use is made of a polymer which is produced without solvent at 100 to 200° C.

18. The process according to claim 12, wherein the biologically fermented solution is a beer or beer-like drink.

19. The process according to claim 12, wherein the biologically fermented solution is an unfiltered material.

20. The process according to claim 12, wherein the polymer used is a component of a dynamic or static filtration process.

21. The process according to claim 12, wherein the polymer used is also used in the upstream production processes water treatment, mashing, wort treatment and/or fermentation.

22. The use of a polymer which comprises 50-99.5% by weight of N-vinylimidazole 0 to 49.5% by weight of another copolymerizable monomer incorporated by polymerization and is produced in the absence of oxygen and polymerization initiators and also in the presence of 0.5 to 10% by weight, based on the monomers, of a crosslinker, for improving the value-determining properties of beer and beer-like drinks.
